(19) United States
(12) Patent Application Publication
(10) Pub. No.: US 2026/0142968 A1
(43) Pub. Date: May 21, 2026

(54) IDENTITY EXPOSURE SURFACE REDUCTION

(71) Applicant: MICROSOFT TECHNOLOGY LICENSING, LLC, Redmond, WA (US)

(72) Inventors: Roi TZADOK, Ramat Gan (IL); Ori HART HERSHCOVICH, Rosh Haayin (IL); Khaled AWAD, Jerusalem (IL); Shai YANNAI, Haifa (IL)

(21) Appl. No.: 19/053,325

(22) Filed: Feb. 13, 2025

Related U.S. Application Data
(60) Provisional application No. 63/721,398, filed on Nov. 15, 2024.

(51) Int. Cl. H04L 9/40

(52) U.S. Cl. CPC H04L 63/083; H04L 63/105

(57) ABSTRACT

Existing security methods fail to dynamically account for inactive users, creating a persistent security vulnerability. The disclosed embodiments automatically protect credentials that are cached on a computing device. This improves the security of the computing device by limiting the number of credentials that are exposed when the device is compromised. In some configurations, historical usage data is analyzed to determine which credentials to protect, such as the credentials of users deemed inactive on the device. Historical usage data may be obtained from event logs stored on the device or the authentication server. Credentials may be protected by encrypting them or by removing them from the device. In some configurations, other types of sensitive information such as browser cookies, saved browser passwords, sensitive files, or documents may also be removed for inactive users.

### CROSS-REFERENCE TO RELATED APPLICATIONS

The present application is a non-provisional application of, and claims priority to, U.S. Provisional Application Ser. No. 63/721,398 filed on Nov. 15, 2024, the contents of which are hereby incorporated by reference in their entirety.

### BACKGROUND

Malicious entities often leverage convenience features of modern computers to increase the scope or severity of cyberattacks. For example, many computers that are managed by an authentication server will cache user credentials locally. These credentials enable the local computing device to authenticate users by itself, granting them access to the device when the authentication server is inaccessible. However, when an attacker compromises the computing device, all of these cached credentials are exposed, giving the attacker access to additional user data and computing functionality. Beyond direct misuse, the attacker may extract password hashes from the cached credentials. These hashes may be subjected to brute force or other cracking techniques to reveal the users'actual passwords, putting other computing resources at risk.

It is with respect to these and other considerations that the disclosure made herein is presented.

### SUMMARY

Existing security methods fail to dynamically account for inactive users, creating a persistent security vulnerability. The disclosed embodiments automatically protect credentials that are cached on a computing device. This improves the security of the computing device by limiting the number of credentials that are exposed when the device is compromised. In some configurations, historical usage data is analyzed to determine which credentials to protect, such as the credentials of users deemed inactive on the device. Historical usage data may be obtained from event logs stored on the device or the authentication server. Credentials may be protected by encrypting them or by removing them from the device. In some configurations, other types of sensitive information such as browser cookies, saved browser passwords, sensitive files, or documents may also be removed for inactive users.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIGS. 1A-1C illustrate storing login credentials on a local computing device.

FIGS. 2A-2C illustrate identifying and removing the stored credentials of inactive users.

FIG. 3 is a flow diagram of an example method for identity exposure surface reduction.

FIG. 4 is a computer architecture diagram illustrating an illustrative computer hardware and software architecture for a computing system capable of implementing aspects of the techniques and technologies presented herein.

### DETAILED DESCRIPTION

In some configurations, login records of a computing device are analyzed to distinguish active users from inactive users. Inactive users may be characterized as infrequent users or users who have not been active for a defined period of time. The credentials of inactive users are then protected. For example, the credentials of inactive users may be removed from the computing device or subject to additional encryption. In this way, at least some user credentials are protected should an attacker gain access to the computing device.

In some configurations, an inactive user identification engine periodically identifies accounts that are inactive on a computing device. Many factors may affect whether a user is deemed inactive on a particular device, such as the frequency or duration of logins. Usage metrics may be evaluated in absolute terms by comparison to predefined thresholds. Additionally, or alternatively, usage metrics may be compared to relative thresholds derived from the usage metrics of related user populations. For example, relative thresholds may be derived from the usage metrics of users of the same device, users within the same organization, or users who have a shared attribute such as the same role.

For example, an inactive user identification engine may analyze an event log to determine which users have logged-in to the computing device in the past month, how many times each user has logged-in, and the duration of each session. The inactive user identification engine may then identify users that do not meet usage thresholds as inactive. Additional protective measures may then be applied to the cached credentials of inactive users.

Other factors may be considered when determining whether to protect a user's credentials. One example is a usage intensity metric, which reflects a degree of user interaction with the computing device. In some configurations, lower usage thresholds are applied to high-intensity users, reducing the amount of time or the frequency of use needed to be identified as active. Biasing high-intensity users towards being identified as active reflects an assumption that high-intensity users derive more utility from using the computing device, and so the harm of preventing a high-intensity user from logging-in is greater than for low-intensity users. In some configurations, a usage intensity metric is computed based on what percentage of time a user has been interacting with the computing device, such as by typing or scrolling. Interactions with the computing device may be measured by counting mouse movements, mouse clicks, or keyboard presses, by measuring durations of mouse movements, or otherwise measuring numbers, durations, or percentages of user interactions with the computing device.

Another factor that may affect the determination to protect a user's credentials is whether the user owns the device. A user is considered the device's owner if the device is the user's personal property or if the device is assigned by an organization to be used primarily by the user. Device ownership may be determined by purchase records or registration data maintained by the device itself, or by a system administrator of the organization the device participates in. In some configurations, a device owner is deemed to be active independent of actual usage history, ensuring that the device owner's credentials remain cached, ensuring that the device owner is able to log in.

In some configurations, the inactive user identification engine identifies when the computing device has changed ownership. Changes in device ownership may trigger a re-evaluation of stored user credentials. For example, the inactive user identification engine may determine that the computing device has been given to a co-worker based on a change in registration or a re-assignment by the system administrator. In this case the old owner's usage history may be re-evaluated without the ownership factor, possibly leading to a determination that the old owner has been inactive and the old owner's credentials should be protected. At the same time, the new owner's cached credentials may be allowed to remain unprotected regardless of usage history.

The role of the computing device may also affect whether a user is deemed active or inactive. In some configurations, different credential caching policies embodying one or more usage thresholds may be applied for different device roles. As referred to herein, a more protective credential caching policy applies higher threshold values when identifying active users, requiring a greater amount of usage before a user is identified as active. As a result, all else being equal, a more protective credential caching policy identifies more users as inactive, causing more user credentials to be protected than a less protective credential caching policy.

One example of a device role that affects credential caching policy is the role of a shared, public device. A shared, public device is expected to store a large number of credentials, increasing the significance of a security breach. At the same time, users may not be expected to use a shared device frequently, and if they do, losing access is less likely to impose a significant cost than losing access to a personal workstation. For example, a computing device employed by a public library may be used by hundreds of users a month, resulting in the accumulation of a significant number of cached credentials. At the same time, being temporarily blocked from logging into a library computer when an authentication server is inaccessible is expected to cause less harm than blocking a user from logging into their personal device. Given this risk profile and expected user impact, shared public devices may be assigned a more protective credential caching policy, increasing the amount and/or frequency of use needed before a user is identified as active and the user's credentials are allowed to remain. In some configurations, the inactive user identification engine detects when a device's role has changed, potentially triggering a re-evaluation of stored user credentials under a different credential caching policy.

Other device roles may trigger a less protective credential retention policy. For example, a computing device that stores large numbers of login credentials outside of a login credentials cache, such as an authentication server that stores credentials in order to process login requests, may receive a more lenient policy or have protection removed entirely. This is because any credentials that would be protected by encryption or removal from the credentials cache would still be stored by the authentication server itself, and as such would still be exposed during a security breach.

Observed usage patterns may also affect how protective of a credential caching policy to apply. For example, the inactive user identification engine may identify an increase in the number of daily active users. For instance, the inactive user identification engine may determine that a defined number or a defined percentage of users have begun logging-in to the device on a regular basis. As a result, a less protective credential caching policy may be adopted, reducing the thresholds needed to identify a user as active and allowing a larger number of credentials to remain cached on the device.

As these examples illustrate, the role of the computer and the number of people who use the computer are both factors when selecting a credential caching policy. Another factor is the number and type of permissions granted to the user. For example, a user with administrative privileges or who otherwise deals with sensitive information may receive more protection by adopting higher usage thresholds. In some configurations, additional policies may be applied that are independent of usage history, such as removing all non-administrative accounts at the end of each day.

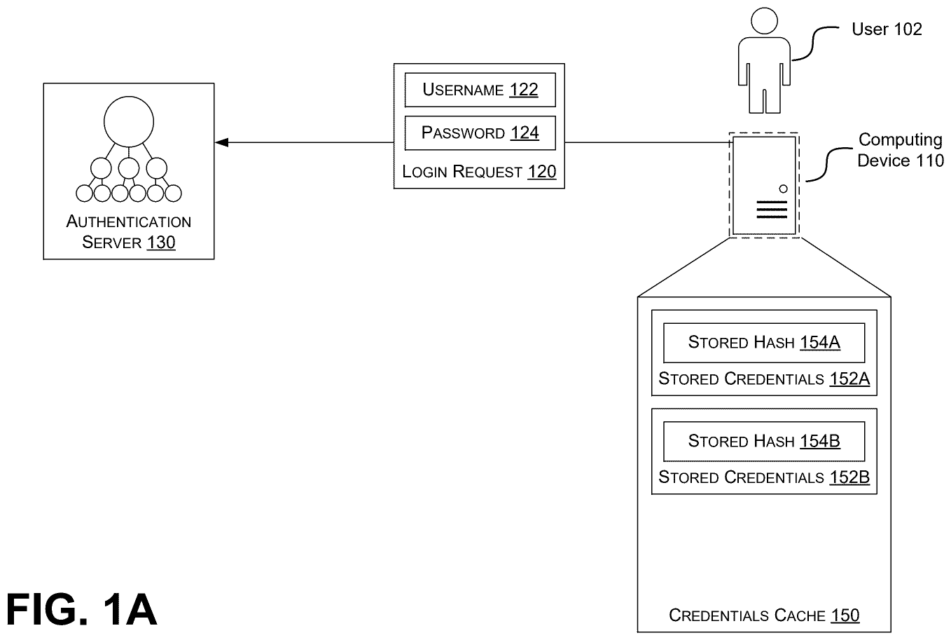

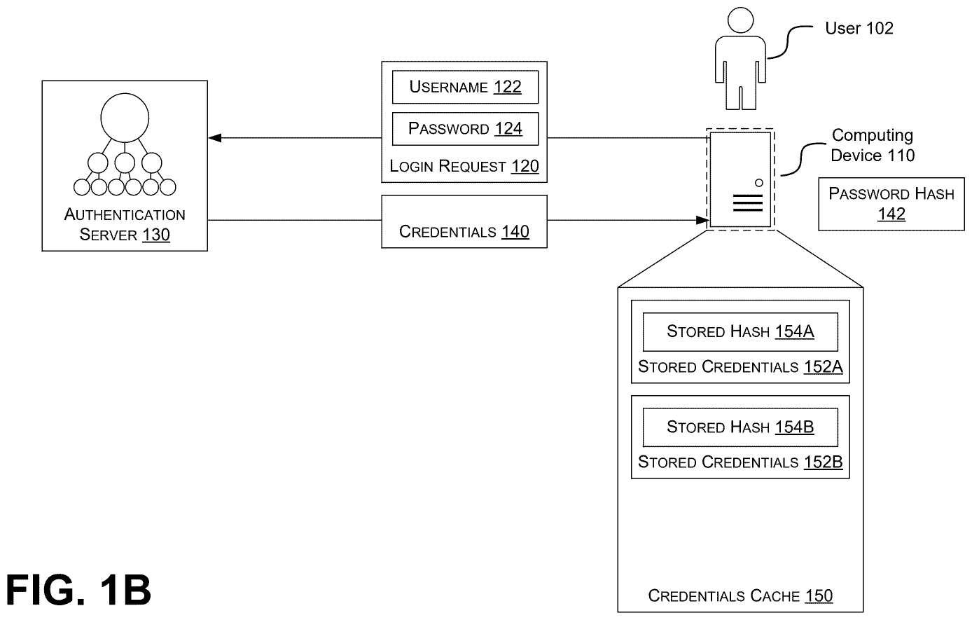

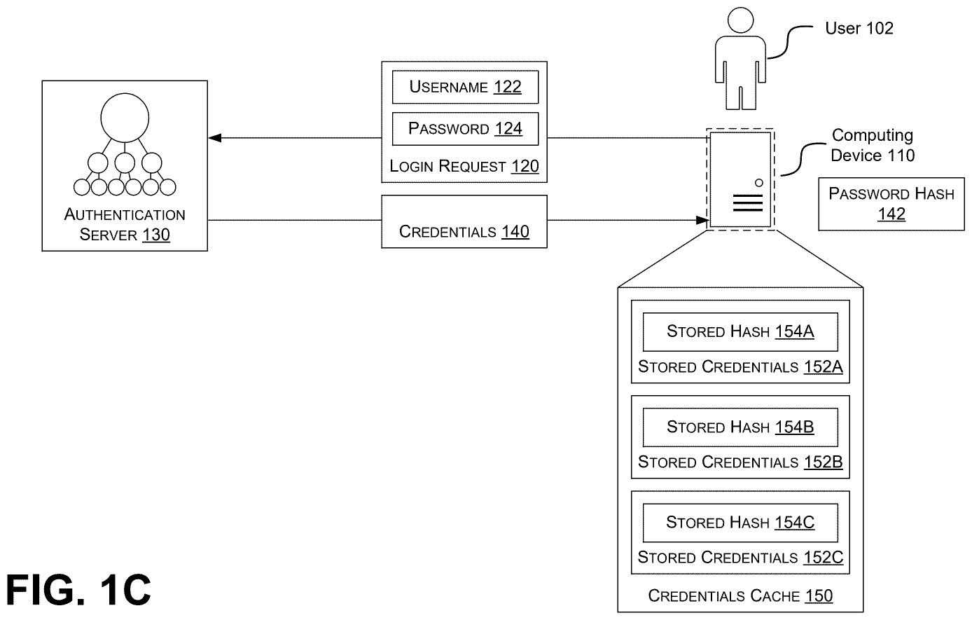

FIGS. 1A-1C illustrate storing login credentials on a local computing device. FIG. 1A illustrates user 102 operating computing device 110 to provide login request 120 to authentication server 130. One example of authentication server 130 is a domain controller. Login request 120 is illustrated as including username 122 and password 124, but other login data such as a two-factor authentication code, a one-time password, fingerprint, facial recognition, or other biometric data, a device identifier, and the like, are similarly contemplated.

Credentials cache 150 of computing device 110 may retain stored credentials 152, including stored hashes 154 or other cryptographic secrets. Stored hashes 154 may be hashes obtained by applying a cryptographic function to data included in login request 120, such as password 124. Computing device 110 may use stored credentials 152 to authenticate user 102 when authentication server 130 is inaccessible.

FIG. 1B illustrates computing device 110 obtaining credentials 140 in response to a successful login attempt. Credentials 140 indicate that user 102 is authorized to use computing device 110. Credentials 140 may include data such as a session ID that identifies a user as they make requests of network resources. Also illustrated is password hash 142, which may be computed by computing device 110. Computing device 110 may derive password hash 142 from password 124 or other data included in login request 120. For example, computing device 110 may apply a cryptographic hash algorithm to password 124 to obtain password hash 142.

FIG. 1C illustrates storing credentials 140 locally in credentials cache 150 as stored credentials 152C. Credentials cache 150 may retain stored credentials 152 obtained from authentication server 130. Credentials cache 150 may also retain stored hashes 154 obtained from computing device 110. Data stored in credentials cache 150 may be used to authenticate user 102 locally when authentication server 130 is inaccessible.

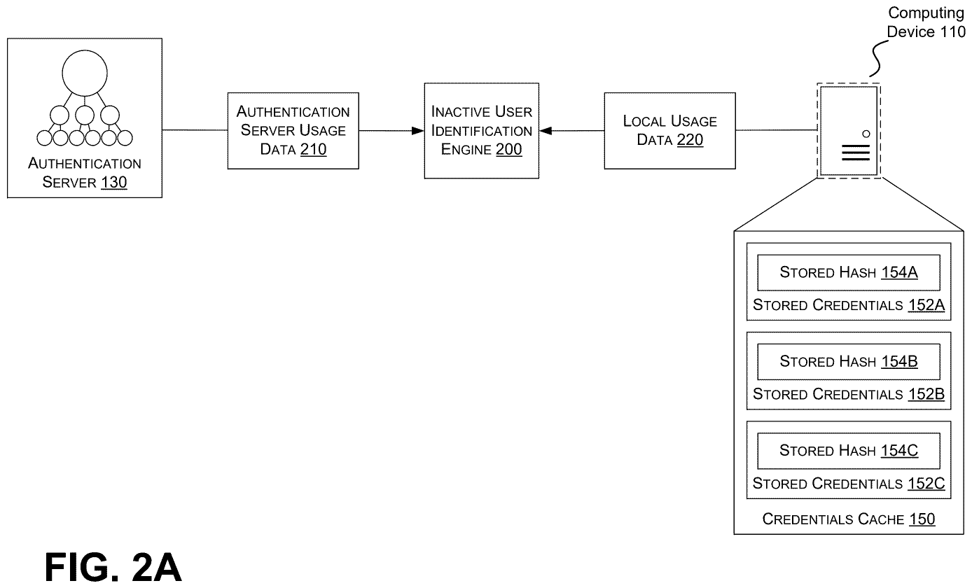

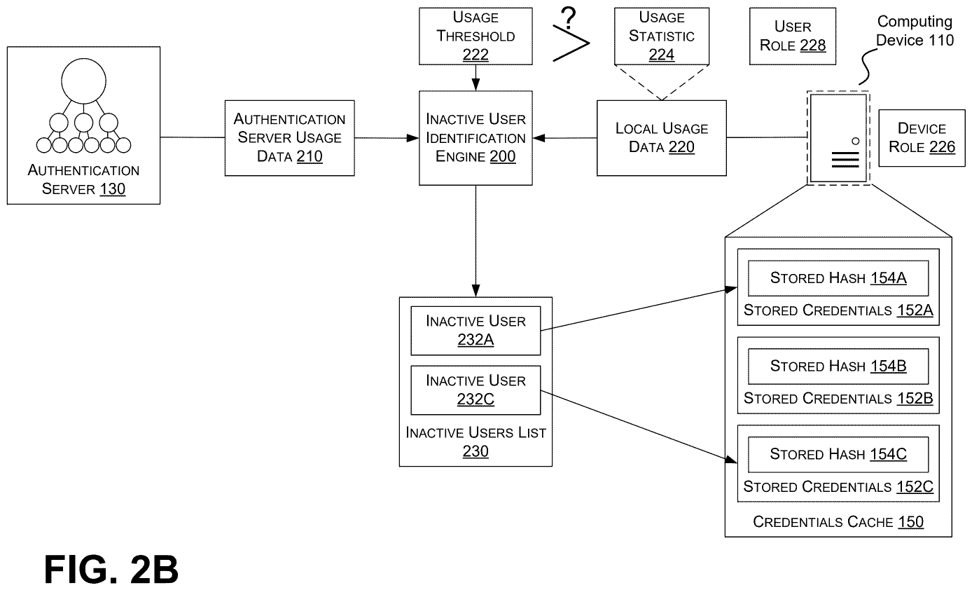

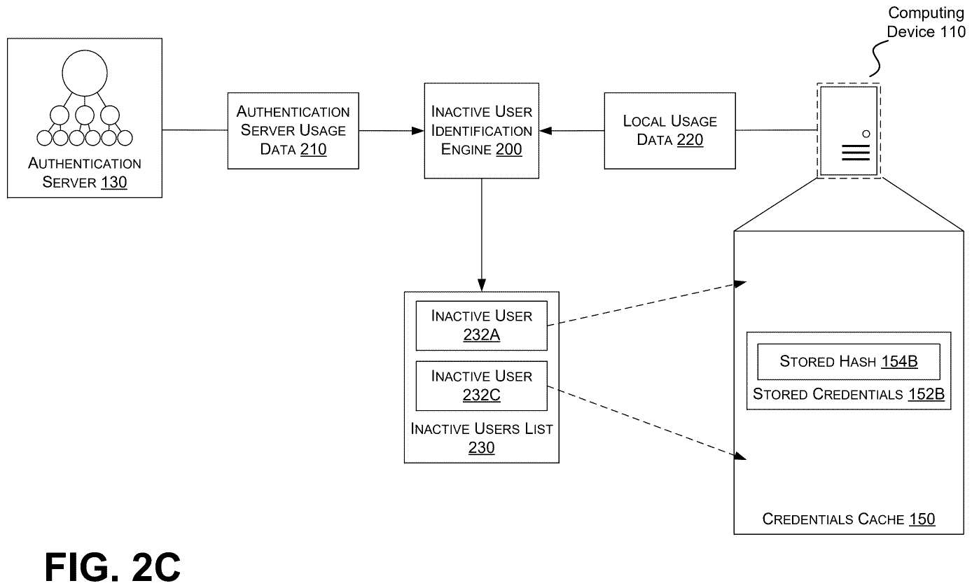

FIGS. 2A-2C illustrate identifying and removing the stored credentials of inactive users. FIG. 2A illustrates inactive user identification engine 200 receiving authentication server usage data 210 from authentication server 130 and/or local usage data 220 from local computing device 110. Usage data may include a history of login events, although other interaction records such as logout events, application engagement metrics, or other data usable to evaluate the length or intensity of use of computing device 110 is similarly contemplated. The history of login events and other types of events may be obtained from an event log, such as an operating system event tracing log that records operating system events and application events.

FIG. 2B illustrates inactive user identification engine 200 analyzing authentication server usage data 210 and/or local usage data 220 to generate inactive users list 230. Inactive users list 230 contains one or more inactive users 232 that have not used computing device 110 enough or in such a way to be identified as active. Server usage data 210 may include a record of login requests for computing device 110. Local usage data 220 may also include a record of login requests, and may come in the form of a system event log. Local usage data 220 may also include user interaction data usable to compute intensity metrics, activity metrics, and other qualitative and quantitative measures of how user 102 has utilized computing device 110. For example, local usage data 220 may include a record of mouse moves, mouse clicks, keyboard presses, touch screen presses, application launches, and other user interaction history data. As illustrated, inactive user 232A is associated with stored credentials 152A and inactive user 232C is associated with stored credentials 152C.

In some configurations, inactive user identification engine 200 adds user 102 to inactive users list 230 when usage statistic 224 fails to meet usage threshold 222. Usage threshold 222 may indicate a type of usage and a value to compare against. Examples of types of usage include a minimum number of logins, a minimum frequency of logins, a minimum usage intensity, or the like, or a combination thereof. Values of usage threshold 222 may defined with a number or a percentage. The value of usage threshold 222 may be an absolute, predefined number or a dynamically computed number that is relative to the usage statistics of other users. One example of such a relative number is to rank users, selecting a defined most frequent users as active while remaining users are added to inactive users list 230. Usage threshold 222 may also specify a defined period of time over which to compute usage statistic 224. For example, usage threshold 222 may indicate that a user who has logged-in at least three times over the past month is an active user.

Inactive user identification engine 200 may compute usage statistic 224 from local usage data 220 and/or authentication server usage data 210. For example, inactive user identification engine 200 may compute a total logged-in time by adding all of the time between login and logout events for user 102. Usage statistic 224 could be any type of statistic to match the type of usage threshold 222, such as a usage frequency, usage amount, usage intensity, etc.

As discussed briefly above, a user's level of activity may be evaluated based on a frequency of use, an amount of usage time, a type of use, usage intensity, or any other usage threshold. How user 102 uses other computing devices may or may not be considered when determining whether user 102 is inactive on computing device 110. In some configurations, the type of usage threshold 222 is selected based on device role 226 and/or user role 228. For example, device role 226 may indicate that computing device 110 is a shared, public computing device. Inactive user identification engine 200 may select to count the number of logins as the type of usage threshold 222 for this role.

Inactive user identification engine 200 may also adjust the type of usage threshold 222 and/or the value of usage threshold 222 based on device role 226 and/or user role 228. One example user role 228 is system administrator. For example, system administrators with at least two logins in the past month may be deemed active.

Another example of user role 228 is the active user role. A user that is currently logged-in to device 110 has the active user role. For this role, inactive user identification engine 200 may allow the active user's credentials to remain cached whether or not the active user exceeds usage threshold 222.

Another example of user role 228 is an owner user of computing device 110. An owner user refers to a user that uses computing device 110 as a primary device, or who is the predominant user of computing device 110, or who has been assigned as the owner of computing device 110 by a system administrator. Inactive user identification engine 200 may retain credentials of the owning user even if usage metric 224 of the owning user does not exceed usage threshold 222.

Inactive user identification engine 200 may also monitor computing device 110 for a change in ownership. When the ownership role changes, and the previous owner's credentials remain cached, inactive user identification engine 200 may re-evaluate, removing the previous owner user's credentials from credentials cache 150 if they fail to meet usage threshold 222.

Other user roles may be singled out for restrictive or lenient usage thresholds 222, such as users with administrative privileges. Users with administrative privileges may have a more restrictive usage threshold 222 applied due to the increased harm that could be caused by exposing administrative privileges. In other configurations, users with administrative privileges may have a more lenient usage threshold 222 applied in order to ensure administrative access is available on a given computing device. In some configurations, credentials for a most recently used or a most frequently used administrative user may be retained while credentials of other administrative users may be removed or otherwise protected.

In some configurations, usage threshold 224 is specific to a device role 226 of computing device 110. For example, if computing device 110 is a public device or shared device, such as in a library, then usage threshold 222 may require a greater login frequency or duration to be considered active than if computing device 110 did not have this role. Conversely, users who login infrequently, even if recently, may be considered inactive.

Another example of applying a different usage threshold 222 based on device role 226 is applying lower usage thresholds to a computing device that stores user credentials in places other than credentials cache 150. For example, an authentication server, such as a domain controller, may store user credentials outside of credentials cache 150 for the purpose of authenticating users. Removing or otherwise protecting these credentials would render the authentication server inoperable, and so these credentials remain on the device regardless of user activity levels. However, these credentials remain on the device in the event that the authentication server is compromised, reducing or eliminating the benefit of removing credentials from credentials cache 150. Accordingly, for devices in these roles, inactive user identification module 200 may adopt a low usage threshold 222 or remove protection entirely.

In some configurations, inactive user identification engine 200 monitors computing device 110 for a change in device role 226. The applicable usage threshold 222 may then be adjusted accordingly. In some configurations, when a change in device role 226 is detected, inactive user identification engine 200 analyzes existing cached credentials 152 in credentials cache 150, removing any that do not exceed the usage threshold 222 of the new role.

FIG. 2C illustrates credentials cache 150 after removing stored credentials 152A and 152C. The removed credentials 152 were removed for being associated with inactive users 232A and 232C, respectively. In some configurations, instead of removing credentials, credentials associated with inactive users are encrypted or otherwise protected without being removed.

In some configurations, other sensitive information associated with inactive users is removed from computing device 110. For example, browser cookies, passwords such as stored web passwords, and other user-specific security sensitive data may be removed by inactive user identification engine 200 in response to determining that a user is inactive. This user-specific information may be identified by reference to a user's home directory, browser cookie cache, browser history, or other user-specific storage location.

In some configurations, a record of which users have had stored credentials 152 removed is retained. When a user whose credentials 152 were removed attempts to login, and authentication server 130 is inaccessible, a determination may be made that the login attempt failed due to removal of the user's cached credentials 152. In some configurations, in response to this determination, an alert may be transmitted to a system administrator indicating that the login failed because cached credentials 152 were removed. The system administrator may be presented with an option to make criteria for identifying inactive users, such as the usage threshold, more lenient.

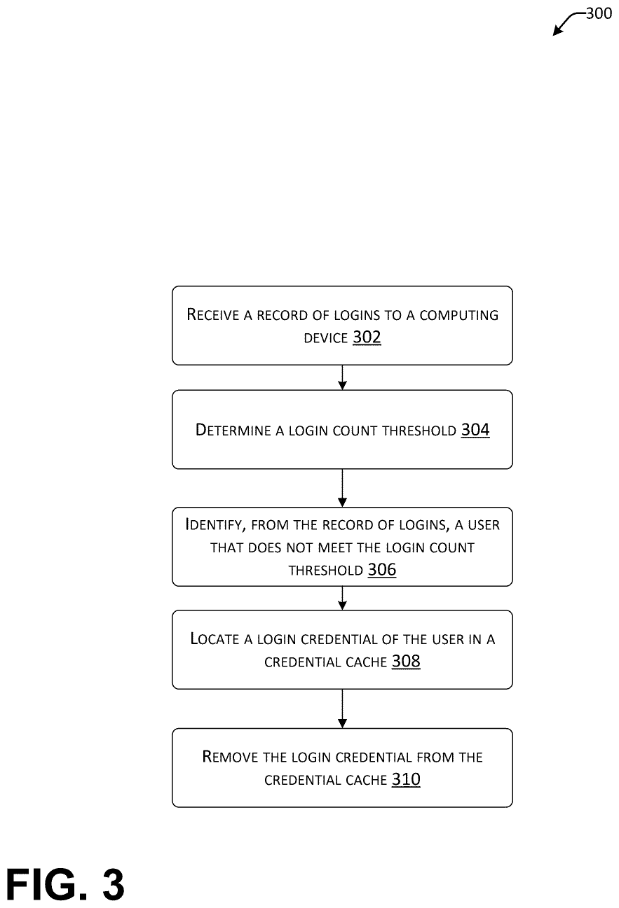

FIG. 3 is a flow diagram of an example method for identity exposure surface reduction. Routine 300 begins at operation 302, where a record of logins of computing device 110—one type of local usage data 220 or authentication server usage data 210—is received.

Next, at operation 304, a determination of a login count threshold 222 is made. This determination may be made based on device role 226 of computing device 110, user role 228 of user 102, etc.

Next at operation 306, a user 102 that does not meet the login count threshold 222 is identified from the received record of logins 220/210.

Next at operation 308, login credential 152A associated with the identified user is identified in credentials cache 150.

Next at operation 310, login credential 152A is removed from credentials cache 150.

The particular implementation of the technologies disclosed herein is a matter of choice dependent on the performance and other requirements of a computing device. Accordingly, the logical operations described herein are referred to variously as states, operations, structural devices, acts, or modules. These states, operations, structural devices, acts, and modules can be implemented in hardware, software, firmware, in special-purpose digital logic, and any combination thereof. It should be appreciated that more or fewer operations can be performed than shown in the figures and described herein. These operations can also be performed in a different order than those described herein.

It also should be understood that the illustrated methods can end at any time and need not be performed in their entireties. Some or all operations of the methods, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For example, the operations of the routine 300 are described herein as being implemented, at least in part, by modules running the features disclosed herein can be a dynamically linked library (DLL), a statically linked library, functionality produced by an application programing interface (API), a compiled program, an interpreted program, a script or any other executable set of instructions. Data can be stored in a data structure in one or more memory components. Data can be retrieved from the data structure by addressing links or references to the data structure.

Although the following illustration refers to the components of the figures, it should be appreciated that the operations of the routine 300 may be also implemented in many other ways. For example, the routine 300 may be implemented, at least in part, by a processor of another remote computer or a local circuit. In addition, one or more of the operations of the routine 300 may alternatively or additionally be implemented, at least in part, by a chipset working alone or in conjunction with other software modules. In the example described below, one or more modules of a computing system can receive and/or process the data disclosed herein. Any service, circuit or application suitable for providing the techniques disclosed herein can be used in operations described herein.

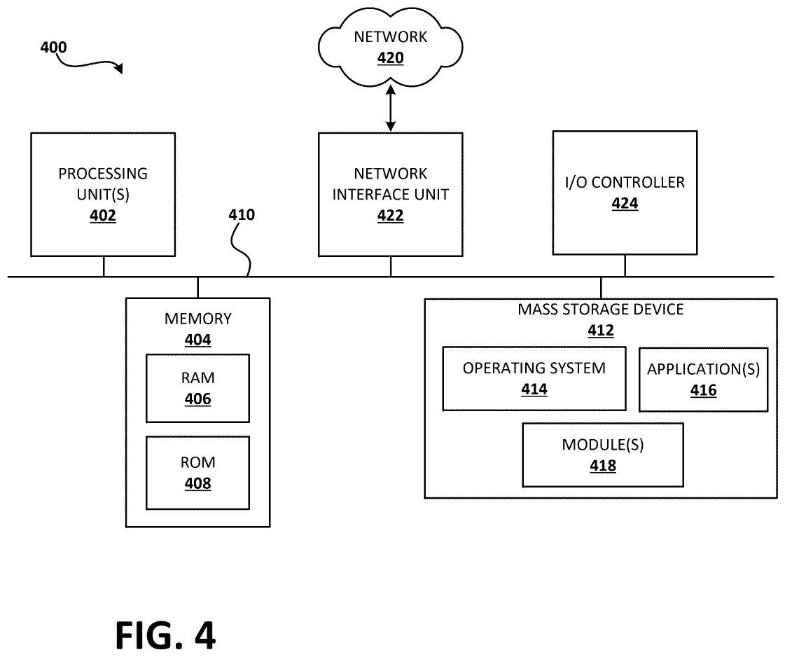

FIG. 4 shows additional details of an example computer architecture 400 for a device, such as a computer or a server configured as part of the systems described herein, capable of executing computer instructions (e.g., a module or a program component described herein). The computer architecture 400 illustrated in FIG. 4 includes processing unit(s) 402, a system memory 404, including a random-access memory 406 (“RAM”) and a read-only memory (“ROM”) 408, and a system bus 410 that couples the memory 404 to the processing unit(s) 402.

Processing unit(s), such as processing unit(s) 402, can represent, for example, a CPU-type processing unit, a GPU-type processing unit, a neural processing unit, a field-programmable gate array (FPGA), another class of digital signal processor (DSP), or other hardware logic components that may, in some instances, be driven by a CPU. For example, and without limitation, illustrative types of hardware logic components that can be used include Application-Specific Integrated Circuits (ASICs), Application-Specific Standard Products (ASSPs), System-on-a-Chip Systems (SOCs), Complex Programmable Logic Devices (CPLDs), etc.

A basic input/output system containing the basic routines that help to transfer information between elements within the computer architecture 400, such as during startup, is stored in the ROM 408. The computer architecture 400 further includes a mass storage device 412 for storing an operating system 414, application(s) 416, modules 418, and other data described herein.

The mass storage device 412 is connected to processing unit(s) 402 through a mass storage controller connected to the bus 410. The mass storage device 412 and its associated computer-readable media provide non-volatile storage for the computer architecture 400. Although the description of computer-readable media contained herein refers to a mass storage device, it should be appreciated by those skilled in the art that computer-readable media can be any available computer-readable storage media or communication media that can be accessed by the computer architecture 400.

Computer-readable media can include computer-readable storage media and/or communication media. Computer-readable storage media can include one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including but not limited to random access memory (RAM), static random-access memory (SRAM), dynamic random-access memory (DRAM), phase change memory (PCM), read-only memory (ROM), erasable programmable read-only memory (EPROM), electrically erasable programmable read-only memory (EEPROM), flash memory, compact disc read-only memory (CD-ROM), digital versatile disks (DVDs), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer-readable storage media, communication media can embody computer-readable instructions, data structures, program modules, or other data in a modulated data signal, such as a carrier wave, or other transmission mechanism. As defined herein, computer storage media does not include communication media. That is, computer-readable storage media does not include communications media consisting solely of a modulated data signal, a carrier wave, or a propagated signal, per se.

According to various configurations, the computer architecture 400 may operate in a networked environment using logical connections to remote computers through the network 420. The computer architecture 400 may connect to the network 420 through a network interface unit 422 connected to the bus 410. The computer architecture 400 also may include an input/output controller 424 for receiving and processing input from a number of other devices, including a keyboard, mouse, touch, or electronic stylus or pen. Similarly, the input/output controller 424 may provide output to a display screen, a printer, or other type of output device.

It should be appreciated that the software components described herein may, when loaded into the processing unit(s) 402 and executed, transform the processing unit(s) 402 and the overall computer architecture 400 from a general-purpose computing system into a special-purpose computing system customized to facilitate the functionality presented herein. The processing unit(s) 402 may be constructed from any number of transistors or other discrete circuit elements, which may individually or collectively assume any number of states. More specifically, the processing unit(s) 402 may operate as a finite-state machine, in response to executable instructions contained within the software modules disclosed herein. These computer-executable instructions may transform the processing unit(s) 402 by specifying how the processing unit(s) 402 transition between states, thereby transforming the transistors or other discrete hardware elements constituting the processing unit(s) 402.

The present disclosure is supplemented by the following example clauses:

Example 1: A method comprising: receiving a record of user logins to a computing device; determining a login count threshold of the computing device; identifying, from the record of user logins, a user that does not meet the login count threshold of the computing device over a defined period of time; locating a login credential of the user stored in a credentials cache; and removing the login credential of the user from the credentials cache.

Example 2: The method of Example 1, wherein the login count threshold is relative to a total number of logins to the computing device.

Example 3: The method of Example 1, further comprising: determining a role of the computing device, wherein the login count threshold is determined based on the role of the computing device.

Example 4: The method of Example 3, further comprising: monitoring the computing device for a change in the role of the computing device; and adjusting the login count threshold based on the change in the role of the computing device.

Example 5: The method of Example 3, wherein the role is determined to be a shared public computing device, and wherein the login count threshold is increased in response to determining the role to be a shared public computing device.

Example 6: The method of Example 1, wherein the login count threshold comprises a login recency threshold, and wherein identifying that the user does not meet the login count threshold comprises determining that the user does not meet the login recency threshold.

Example 7: The method of Example 1, wherein the login count threshold comprises a login frequency threshold, and wherein identifying that the user does not meet the login count threshold comprises determining that the user does not meet the login frequency threshold.

Example 8: A non-transitory computer-readable storage medium having computer-executable instructions stored thereupon that, when executed by a processor, cause the processor to: receive usage data of a computing device; determine a usage threshold of the computing device; identify, from the usage data, a user that fails to meet the usage threshold of the computing device; locate a login credential of the user stored in a credentials cache; and protect the login credential of the user stored in the credentials cache.

Example 9: The non-transitory computer-readable storage medium of Example 8, wherein the usage data is received from an event log of an authentication server or an event log of the computing device.

Example 10: The non-transitory computer-readable storage medium of Example 8, wherein the instructions further cause the processor to: determine a role of the computing device, wherein determining the usage threshold of the computing device is based on the determined role of the computing device.

Example 11: The non-transitory computer-readable storage medium of Example 8, wherein protecting the login credential of the user comprises encrypting or deleting the login credential of the user.

Example 12: The non-transitory computer-readable storage medium of Example 8, wherein identifying a user that fails to meet the usage threshold comprises determining that the user is not an owner of the computing device.

Example 13: The non-transitory computer-readable storage medium of Example 8, wherein the instructions further cause the processor to: identify a first owner user of the computing device; monitor the computing device for a change of ownership to a second owner user; and protect the login credential of the first owner user in response to the change of ownership to the second owner user.

Example 14: A computing device comprising: a processor; and a non-transitory computer-readable storage medium storing computer-readable instructions that, when executed by the processor, cause the computing device to: receive a record of user logins to a computing device; determine, from the record of user logins, a login frequency of a user of the computing device; select a login threshold based on a role of the computing device; determine that the login frequency of the user of the computing device fails to meet the login threshold; identify a login credential of the user stored on a credentials cache of the computing device; and remove the login credential of the user from the credentials cache of computing device.

Example 15: The computing device of Example 14, wherein the instructions further cause the processor to: remove or encrypt sensitive information of the inactive user.

Example 16: The computing device of Example 15, wherein the sensitive information comprises a browser cookie, a password, a document, or a file.

Example 17: The computing device of Example 14, wherein the instructions further cause the computing device to: determine that a user login attempt failed because the login credential of the inactive user was removed; and alert a system administrator that the user login attempt failed because the login credential of the inactive user was removed.

Example 18: The computing device of Example 17, wherein the instructions further cause the computing device to: modify the login threshold to be more lenient.

Example 19: The computing device of Example 14, wherein the instructions further cause the computing device to: determine a role of the computing device; and adjust the login threshold according to the determined role.

Example 20: The computing device of Example 19, wherein the role is determined to be a shared computing device, and wherein the login threshold is made less lenient.

While certain example embodiments have been described, these embodiments have been presented by way of example only and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

It should be appreciated that any reference to “first,” “second,” etc. elements within the Summary and/or Detailed Description is not intended to and should not be construed to necessarily correspond to any reference of “first,” “second,” etc. elements of the claims. Rather, any use of “first” and “second” within the Summary, Detailed Description, and/or claims may be used to distinguish between two different instances of the same element.

In closing, although the various techniques have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

What is claimed is:

1. A method comprising:
receiving a record of user logins to a computing device;
determining a login count threshold of the computing device;
identifying, from the record of user logins, a user that does not meet the login count threshold of the computing device over a defined period of time;
locating a login credential of the user stored in a credentials cache; and
removing the login credential of the user from the credentials cache.

2. The method of claim 1, wherein the login count threshold is relative to a total number of logins to the computing device.

3. The method of claim 1, further comprising:
determining a role of the computing device, wherein the login count threshold is determined based on the role of the computing device.

4. The method of claim 3, further comprising:
monitoring the computing device for a change in the role of the computing device; and
adjusting the login count threshold based on the change in the role of the computing device.

5. The method of claim 3, wherein the role is determined to be a shared public computing device, and wherein the login count threshold is increased in response to determining the role to be a shared public computing device.

6. The method of claim 1, wherein the login count threshold comprises a login recency threshold, and wherein identifying that the user does not meet the login count threshold comprises determining that the user does not meet the login recency threshold.

7. The method of claim 1, wherein the login count threshold comprises a login frequency threshold, and wherein identifying that the user does not meet the login count threshold comprises determining that the user does not meet the login frequency threshold.

8. A non-transitory computer-readable storage medium having computer-executable instructions stored thereupon that, when executed by a processor, cause the processor to:
receive usage data of a computing device;
determine a usage threshold of the computing device;
identify, from the usage data, a user that fails to meet the usage threshold of the computing device;
locate a login credential of the user stored in a credentials cache; and
protect the login credential of the user stored in the credentials cache.

9. The non-transitory computer-readable storage medium of claim 8, wherein the usage data is received from an event log of an authentication server or an event log of the computing device.

10. The non-transitory computer-readable storage medium of claim 8, wherein the instructions further cause the processor to:
determine a role of the computing device, wherein determining the usage threshold of the computing device is based on the determined role of the computing device.

11. The non-transitory computer-readable storage medium of claim 8, wherein protecting the login credential of the user comprises encrypting or deleting the login credential of the user.

12. The non-transitory computer-readable storage medium of claim 8, wherein identifying a user that fails to meet the usage threshold comprises determining that the user is not an owner of the computing device.

13. The non-transitory computer-readable storage medium of claim 8, wherein the instructions further cause the processor to:
identify a first owner user of the computing device;
monitor the computing device for a change of ownership to a second owner user; and
protect the login credential of the first owner user in response to the change of ownership to the second owner user.

14. A computing device comprising:
a processor; and
a non-transitory computer-readable storage medium storing computer-readable instructions that, when executed by the processor, cause the computing device to:
receive a record of user logins to a computing device;
determine, from the record of user logins, a login frequency of a user of the computing device;
select a login threshold based on a role of the computing device;
determine that the login frequency of the user of the computing device fails to meet the login threshold;
identify a login credential of the user stored on a credentials cache of the computing device; and
remove the login credential of the user from the credentials cache of the computing device.

15. The computing device of claim 14, wherein the instructions further cause the processor to:
remove or encrypt sensitive information of the inactive user.

16. The computing device of claim 15, wherein the sensitive information comprises a browser cookie, a password, a document, or a file.

17. The computing device of claim 14, wherein the instructions further cause the computing device to:
determine that a user login attempt failed because the login credential of the inactive user was removed; and
alert a system administrator that the user login attempt failed because the login credential of the inactive user was removed.

18. The computing device of claim 17, wherein the instructions further cause the computing device to:
modify the login threshold to be more lenient.

19. The computing device of claim 14, wherein the instructions further cause the computing device to:
determine a role of the computing device; and
adjust the login threshold according to the determined role.

20. The computing device of claim 19, wherein the role is determined to be a shared computing device, and wherein the login threshold is made less lenient.
